(19) United States
(12) Patent Application Publication
(10) Pub. No.: US 2021/0005118 A1
(43) Pub. Date: Jan. 7, 2021

(54) Pole Safety Apparatus

(71) Applicants: Jim Kennedy, Victoria (CA); Dalton Karlstrom, Langley (CA)

(72) Inventors: Jim Kennedy, Victoria (CA); Dalton Karlstrom, Langley (CA)

(21) Appl. No.: 16/503,523

(22) Filed: Jul. 4, 2019

(51) Int. Cl. G09F 13/16; G02B 7/182

(52) U.S. Cl. CPC G09F 13/16; G02B 7/182

(57) ABSTRACT

A safety apparatus having a first half-shell component, a second half-shell component and at least one strip of reflective material affixed to both half-shell components. The first half-shell component has a first interior surface and a first exterior surface and defines a first c-shape cross-section. The second half-shell component has a second interior surface and a second exterior surface and defines a second c-shape cross-section. The first half-shell component and the second half-shell component are configured to form a cylindrically shaped housing when connected to each other. The cylindrically shaped housing allows the apparatus to be attached to a power pole, post or other obstacle. At least one strip of reflective material is affixed to the exterior surfaces of the half-shell components in a manner to provide high visibility.

### REFERENCE TO PENDING APPLICATIONS

This application does not claim the benefit of pending application.

### BACKGROUND OF THE INVENTION

### 1. Field of the Invention

The present invention is generally directed toward a safety apparatus, and more specifically, toward a safety apparatus used with a pole, such as a power pole.

### 2. Description of the Related Art

When working around poles, post and trees, workers need to be aware of their location in relation to those obstacles. It is common for workers to inadvertently come into contact with these obstacles which often times results in injury to the worker and damage to equipment.

Accordingly, there is a need for a safety apparatus that addresses the needs set out above.

### SUMMARY OF THE INVENTION

In one aspect of the present invention, a safety apparatus to be attached to a pole, post or other obstacle is disclosed. The safety apparatus includes a first half-shell component, a second half-shell component and at least one strip of reflective material affixed to both half-shell components.

The first half-shell component has a first interior surface and a first exterior surface and defines a first c-shape cross-section. The second half-shell component has a second interior surface and a second exterior surface and defines a second c-shape cross-section. When connected to each other, the first half-shell component and the second half-shell component form a cylindrically shaped housing. This housing is secured around a post or pole.

The strip of reflective material is affixed to the exterior surfaces of both half-shell components in a manner to provide high visibility. In some aspects, the half-shell components are constructed from reflective material, or colored in a manner to provide high visibility. For example, the half-shell components may be constructed from a bright orange plastic material.

In some aspects, the half-shell components may include two flanges radially extending away therefrom. These flanges may include an opening to receive a fastener, such as bolt and nut.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The figures which accompany the written portion of this specification illustrate embodiments and method(s) of use for the present invention constructed and operative according to the teachings of the present invention.

FIG. 1 is a side view of an embodiment of the present invention attached to a pole.

FIG. 2 is a front perspective view of an embodiment of a half shell in accordance with the present invention.

FIG. 3 is a front view of an embodiment of the present invention attached to a pole.

The various embodiments of the present invention will hereinafter be described in conjunction with the appended drawings, wherein like designations denote like elements.

### DETAILED DESCRIPTION

The present invention is generally directed toward a safety apparatus, and more specifically, toward a safety apparatus used with a pole, such as a power pole.

As used herein, the term pole may mean an upright piece of metal or wood that is used to support one or more items, including but not limited to a power pole, metal post, tree or installed posts or piles on land and on riverways.

This invention relates to a pole safety apparatus including a pipe clamp and particularly to a type thereof consisting of two half shell components which, when connected, will form a cylindrically shaped housing and which are connectible to each other through suitable cooperative connecting fasteners and which are readily disconnectible from each other. The apparatus further includes a reflective material attached to the exterior surface of the pipe clamp to provide high visibility.

Each half shell component has an outward c-shape cross section and two, projecting flanges that extend radially away therefrom. Each flange has an opening configured to receive a fastener. The half shells are connected to each other by aligning the openings of each flange, inserting a fastener through each flange opening and securing the fasteners to the flanges. The resulting cylindrical shaped housing allows for the safety apparatus to be securing to a pipe or pole, such a power pole.

The dimensions of the cylindrical shaped housing being sufficiently large enough to extend around the pole, while being able to be secured to the pole at a height. For example, the safety apparatus is securing to a power pole a height of six feet above the ground. The dimensions of the safety apparatus will allow the safety apparatus to extend around the pole while maintaining a secured height of six feet above the ground.

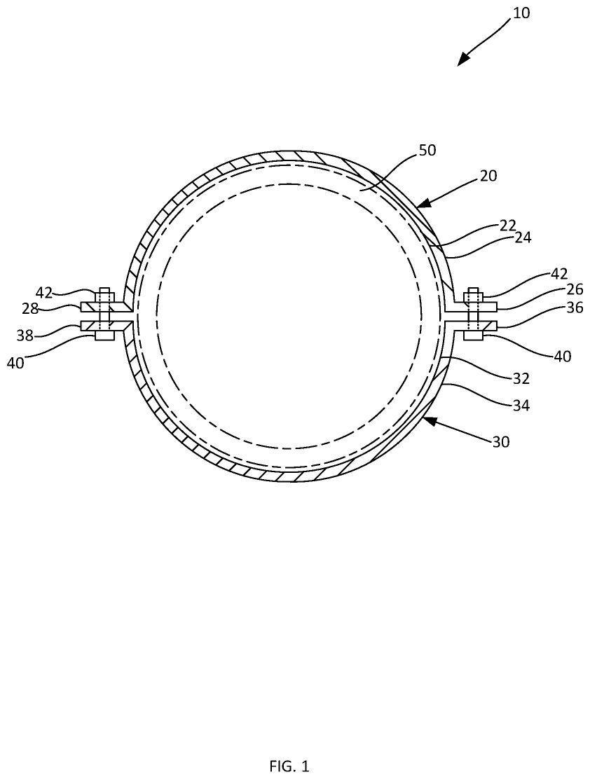

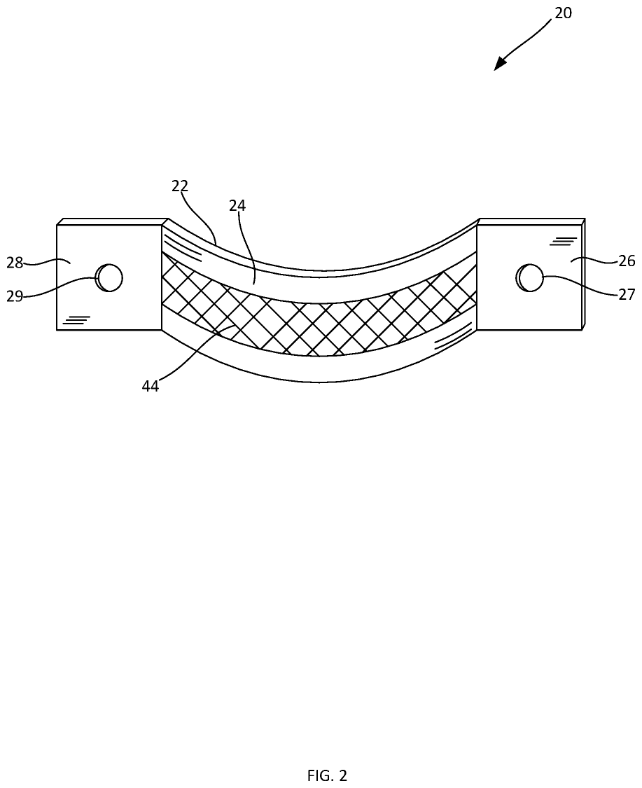

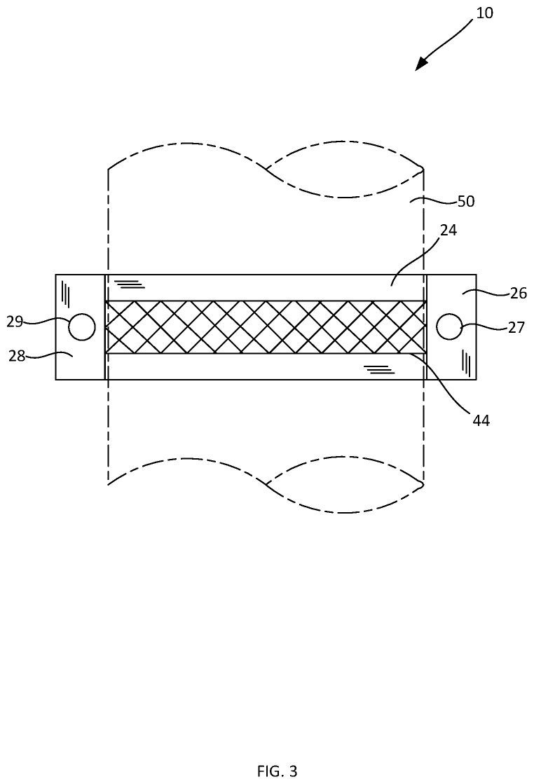

As illustrated in FIGS. 1-3, an embodiment of the safety apparatus 10 of the present invention is disclosed. In this embodiment, safety apparatus 10 is secured to a pole 50 and includes a first half-shell component 20 and a second half-shell component 30. Each half-shell component 20, 30 has an interior surface 22, 32 and an exterior surface 24, 34 that defines an outward c-shape cross such that when secured together form a cylindrical shaped housing that extends around the circumference of the pole 50.

Each half-shell component 20, 30 further includes a first flange 26, 36 and a second flange 28, 39 that extend radially away from the half-shell component 20, 30 respectively. Each flange 26, 28, 38, 39 has an opening 27, 29, 37, 39 that is configured to receive a fastener. In this embodiment, fastener is illustrated to be a bolt 40 and nut 42.

Affixed to the exterior surface 24, 34 of each half-shell component is a piece of reflective material 44 that provides visual awareness to persons who may be proximity while working on or around pole 50. The reflective material 44 provides visibility and protection to those persons. Reflective material 44 may constructed from any known any reflective material and may be in form of a reflective tape, reflective paint or other known reflective material.

First and second half-shell components 20, 30 being constructed from any durable material, including, but not limited to metal and/or plastic. In some embodiments, first and second half-shell components 20, 30 may be constructed from a high-visibility material such as a coloured plastic, e.g. a bright orange coloured plastic material.

Bolt 40 and nut 42 may be any type of bolt and nut, including a nylon bolt and nut. Further, the use of bolt 40 and nut 42 are illustrative and not meant to be limiting. Those skilled in the art will recognize that other fasteners that can secure the apparatus 10 to a pole 50 may be used and would be within the scope of the present invention. For example, the half-shells may be secured by a ratchet-type of fastener. Additionally, the fastener may be removeable, i.e. to allow the apparatus to be removed from the post after a short time, or permanent, i.e. to allow the apparatus to be secured to a post for an indefinite period of time.

The exact specifications and materials used in the manufacture of the apparatus of the present invention may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

I claim:

1. A safety apparatus comprising:
a first half-shell component having a first interior surface and a first exterior surface and defining a first c-shape cross-section,
a second half-shell component having a second interior surface and a second exterior surface and defining a second c-shape cross-section, the first half-shell component and the second half-shell component being configured to form a cylindrically shaped housing when connected thereto;
at least one strip of reflective material affixed to the first exterior surface in a manner to provide high visibility; and
at least one strip of reflective material affixed to the second exterior surface in a manner to provide high visibility.

2. The safety apparatus of claim 1, wherein
the first half-shell component further comprises a first flange having a first opening and a second flange having a second opening; and
the second half-shell component further comprises a third flange having a third opening and a fourth flange having a fourth opening,
the openings being configured to receive a fastener therethrough;
at least one fastener configured to be inserted through at least one opening to connect the first half-shell component to the second half-shell component,

3. The safety apparatus of claim 2, wherein the at least one fastener is a bolt and a nut.

4. The safety apparatus of claim 1, wherein the the first half-shell component and the second half-shell component are constructed from reflective material in a manner to provide high visibility.
